(19) United States
(12) Patent Application Publication
(10) Pub. No.: US 2006/0251091 A1
(43) Pub. Date: Nov. 9, 2006

(54) Communication control unit and communication control method

(75) Inventor: Atsushi Terauchi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/188,321

(22) Filed: Jul. 25, 2005

(30) Foreign Application Priority Data
Mar. 29, 2005 (JP) JP2005-095417

(51) Int. Cl. H04L 12/56

(52) U.S. Cl. 370/412

(57) ABSTRACT

To provide a communication control unit and a communication control method that is resistive against a high processing load, can be implemented at low cost, and realizes priority control according to call setting information. The communication control unit includes a unit connecting plural communication control units between a calling communication control unit and a called communication control unit on the basis of the call setting information and securing a sufficient band between the calling communication unit and the called communication unit. The communication control unit executes plural rules for extracting communication information from a unit for plural storages, which store the communication information, on the basis of the call setting information and transferring the communication information.

### BACKGROUND OF THE INVENTION

The present invention relates to a communication control unit and a communication control method.

Various communication control units have been studied for efficient communication on networks. For example, when a real-time communication service such as streaming of videos is necessary, packets must not be delayed. However, in the case of electronic mails, it matters little if packets are delayed more or less. Therefore, communication qualities required by terminals and communication control units on networks are not determined uniformly. Thus, there have been proposed technologies for allocating bands to be used according to requests from terminals to control qualities of communication among terminals and among communication control units (QoS (Quality of Service) technologies) The QoS technologies are required for performing various services efficiently.

In communication control units using the QoS technologies, in order to improve qualities of communication among terminals and communication control units, parameters such as transfer delay, fluctuation (fluctuation in delay), minimum guaranteed speed, and peak speed are prepared for control of packets.

There is Intserv as one of QoS technologies. Intserv is one of terms defined by the Internet Engineering Task Force (IETF). Intserv connects a calling terminal unit and a called terminal unit to form a path through several communication control units. In establishing a path, Intserv establishes connection with a transmission quality required by a calling communication unit or a called communication unit. After securing the path, Intserv provides a service for transmitting data between the calling terminal unit and the called terminal unit. Because of such a mechanism, Intserv is known as a guarantee-type QoS technology for guaranteeing a transmission quality. Intserv uses a call setting procedure (call setting information), which is called signaling, to connect and secure a path between the calling communication unit and the called communication unit. A path of a network between a calling communication control unit and a called communication control unit secured by signaling is called a micro-flow. On the other hand, a QoS technology of a type for not securing a path between a calling communication unit and a called communication unit is known as Diffserv.

Intserv exchanges data with a target communication unit after securing a path (micro-flow) through which packets pass. Therefore, Intserv is superior in terms of priority control to Diffserv in which a path through which packets pass changes from time to time.

### SUMMARY OF THE INVENTION

However, since Intserv secures and manages a micro-flow according to call setting information, and processes packets passing through the micro-flow, a processing load on software is large and a large number of hardware resources are required. For example, when 2048 micro-flows on a router having a function of Intserv are to be processed, 2048 queues capable of performing scheduling in a fixed band have to be prepared. Since the processing load is thus large, there is a disadvantage that Intserv cannot be applied to a network in which the number of micro-flows increases easily. Moreover, since a large number of hardware resources are required as described above, there is another disadvantage that cost of hardware is extremely high.

The present invention has been devised in view of the above. It is an object of the present invention to provide a communication control technology that can be applied even to a communication system with limited hardware resources by making it possible to perform priority control of packets and suppressing an increase in processing load.

In order to solve the problems, the present invention adopts the following procedures.

(1) A communication control unit comprising: a unit receiving call setting information requesting setting of a communication path that connects a calling communication unit on a first network to a called communication unit on a second network; a storing unit storing including plural storage areas temporarily accumulating, in transferring communication information transmitted from the first network to the second network through the communication path, the communication information following wait for transfer; a storage control unit forming plural queues having different communication qualities for the communication information due to the wait for transfer, in reading out the communication information from the storage areas; a selecting unit selecting any one of the plural queues according to designation of the call setting information; and a transferring unit transferring the communication information of the first network to the second network according to a quality of communication through the selected queue.

According to the structure, the communication control unit can receive call setting information, select a necessary queue from plural queues storing communication information, and provide a communication path corresponding to the call setting information.

(2) The communication control unit may further include: a unit identifying communication information received between the calling communication control unit and the called communication unit; and a unit storing the identified communication information in the selected queue.

According to the structure, the communication control unit can identify communication information and store the communication information in the storing unit.

(3) The communication control unit may be structured such that the call setting information includes requested band information designating a necessary bandwidth of the communication path, and the communication control unit includes: a first disposal object classifying unit classifying, when a normal bandwidth to be used normally is designated as the requested band information, communication information as an object to be disposed of in the communication path on the basis of the normal bandwidth; and a second disposal object classifying unit classifying, when a temporary bandwidth or an amount of information transferred by the temporary bandwidth in an unsteady state is designated as the requested band information other than the normal bandwidth to be used normally, communication information as an object to be disposed of in the communication path in two stages on the basis of the normal bandwidth and the temporary bandwidth or on the basis of the normal bandwidth and the amount of transferred information.

According to the structure, it is possible to classify communication information to be disposed of according to whether a normal bandwidth is designated or whether a temporary bandwidth in an unsteady state is designated in addition to the normal bandwidth.

(4) The communication control unit may further comprise a disposal processing unit disposing of the communication information according to a disposal procedure different for each piece of the classified communication information.

According to the structure, it is possible to dispose of communication information according to different disposal procedures.

(5) The storing unit may include one or more fixed length queues in which the number of pieces of the communication information to be stored is limited to be equal to or lower than a predetermined value, and one or more variable length queues in which the number of pieces of the communication information to be stored is variable.

According to the structure, for example, the communication control unit can use a fixed queue length and a variable queue length properly according to call setting information.

(6) The communication control unit may be structured such that the communication quality due to the wait for transfer through the storing unit includes a band guarantee characteristic with which a bandwidth of communication information is guaranteed, a relative band guarantee characteristic with which relative priorities for plural storing units are guaranteed, or a non-guarantee band characteristic without bandwidth guarantee.

According to the structure, the communication control unit can transfer communication information with a different communication quality such as the band guarantee characteristic, the relative band guarantee characteristic, or the non-guarantee band characteristic without band guarantee according to call setting information.

(7) The communication control unit may be structured such that the queues include a fixed speed readout unit reading out communication information stored at a predetermined fixed speed or at a speed less than a predetermined speed, a weighted readout unit reading out communication information at a rate of relative readout speed among related plural queues, or a unfixed readout unit reading out communication information without control of readout speed.

According to the structure, the communication control unit can send communication information to a partner communication unit using different kinds of queues according to call setting information.

(8) The communication control unit may be structured such that the communication quality includes a transfer bandwidth for transferring the communication information, the transferring unit divides communication information into communication information of a fixed data length and transfers the communication information, and the communication control unit further includes: a unit calculating an average data length of communication information passing through the communication path; and a unit correcting the transfer bandwidth on the basis of a relation between the average data length and the fixed data length.

According to the structure, the communication control unit can correct a transfer bandwidth on the basis of an average data length of communication information.

(9) The communication control unit may further include a reselecting unit selecting a queue transferring the communication information again on the basis of priority designation information which is set in the communication information to be transferred through the communication path and indicates a priority at the time of transfer of the communication information.

According to the structure, the communication control unit can reselect a queue, which was selected once, in accordance with communication information.

(10) The communication control unit may further include: a unit calculating a temporary bandwidth in an unsteady state of communication information to be transferred through the communication path; and a reselecting unit selecting a queue for transferring the communication information again when the temporary bandwidth in the unsteady state is large.

According to the structure, when a temporary bandwidth of an unsteady state of communication information to be transferred through the communication path is large, the communication control unit can reselect a queue for communication information passing through the communication path. The present invention may be a communication control method that is executed by the communication control unit described above.

The present invention makes it possible to perform priority control for packets and implement the functions of the QoS technology by signaling with a small limited number of hardware resources.

### BRIEF DESCRIPTION OF THE DRAWINGS

FIG. 1 is a system diagram of a communication system according to the present invention.

FIG. 2 is a diagram showing a process of processing of a queuing system in a form of being divided into classes.

FIG. 3 is a diagram showing logical blocks of buffers.

FIG. 4 is a first flowchart showing a setting method for the communication system of the present invention according to call setting information.

FIG. 5 is a second flowchart showing the setting method for the system according to the call setting information.

FIG. 6 is a third flowchart showing the setting method for the system according to the call setting information.

FIG. 7 is a last flowchart showing the setting method for the system according to the call setting information.

FIG. 8 is a flowchart showing processing in the case in which 2 Rate 3 Color metering is adopted.

FIG. 9 is a flowchart showing a modification of the present invention.

### DETAILED DESCRIPTION OF THE PREFERRED EMBODIMENT

A communication control unit according to a best mode for carrying out the present invention (hereinafter referred to as embodiment mode) will be hereinafter explained with reference to the drawings. A structure of the embodiment mode described below is only an example and the present invention is not limited to the structure of the embodiment mode.

In this embodiment mode, a principle of the communication system, a structure of the unit and an operation of the unit, and an embodiment will be explained in this order.

<<Principle of a System>>

In the communication system, when a request for communication from a calling communication unit to a partner communication unit is sent to a communication control unit, the communication control unit of the communication system searches for a transmission destination of call setting information (signaling) with a search engine provided in the communication control unit. On the basis of a result of the search, the communication control unit sends the call setting information to a next communication control unit or communication unit. The next communication control unit or communication unit, which has received the call setting information, searches for a next communication control unit or communication unit with a search engine provided in the communication control unit and sends the call setting information to a further next communication control unit or communication unit. In this way, the communication control unit of the communication system secures a path, that is, a band for performing communication between the calling communication unit and the partner communication unit (the called communication control unit). The path is called a micro-flow.

Thereafter, data is communicated on a fixed transmission path between the calling communication unit and the called communication unit with ACK or call setting information from the called communication unit, which informs that the calling communication unit and the called communication unit have been connected, as a start point. In the communication control unit, a band width to be secured on the transmission path is determined according to a request from the calling communication unit (call setting information including a band width corresponds to “requested band information” of the present invention). However, when there is no instruction concerning a band width from the calling communication unit, the communication control unit allocates a predetermined band set in advance by the communication control unit. When the data communication ends, the calling communication unit or the called communication unit sends ACK or call release information to a path fixed by the call setting information, whereby the communication control unit opens paths for data communication established on the communication control unit.

According to the procedures described above, establishment of a path for data communication, securing of a band width, data communication, and opening of a path are performed, respectively.

On the other hand, the communication control unit reads a command for a method of processing packets flowing on a path, which is established later on the basis of call setting information, from the call setting information at the same stage as the securing of a communication path. The communication control unit sets a processing method for a priority control for packets (communication information), which are to flow to the communication control unit, on the basis of the command.

Next, the processing method for the priority control for packets, which is set by the communication control unit on the basis of call setting information, will be explained.

<Setting for the System According to Call Setting Information>

The communication system classifies micro-flows on the basis of call setting information for the priority control for packets. The classes are used as classification concerning the priority control for packets.

The communication control unit measures a quantity of flow of packets for each of the micro-flows before storing the packets in queues in a buffer. The communication control unit judges whether or not the packets of the class are to be disposed of. The communication control unit disposes of all or a part of packets judged to be disposed of.

The communication system temporarily stores the packets, which have not been disposed of, in the queues in the buffer in order to send the packets from the communication control unit. After temporarily storing the packets in the queues in the buffer, the system sends the packets in the queues to a next communication control unit or communication unit in accordance with setting information in the call setting information. A rule for sending the packets in the queues is called queuing.

Several kinds of systems for the queuing have been proposed. The communication system has three kinds of queuing systems, namely, Shaping, WFQ (Weighted Fair Queuing), and Best Effort. A communication control unit executing the Shaping corresponds to the “fixed speed readout unit” of the present invention. A communication control unit executing the WFQ corresponds to the “weighted readout unit” of the present invention. A communication control unit executing the Best Effort corresponds to the “unfixed readout unit” of the present invention. The communication control unit executing those queuing systems corresponds to the “storage control unit” of the present invention. The Shaping, the WFQ, the Best Effort will be explained hereinafter.

The Shaping is a queuing system for adjusting packets to be sent from the communication control unit on the basis of a QoS technology and transmission speed of a line. The packets adjusted by the Shaping are sent to a partner communication unit at fixed speed or speed in a fixed range. In the Shaping, data may be transferred to the partner communication unit at a fixed packet length (the communication control unit executing the Shaping divides information into information of a fixed data length and transfers the information). The communication system has two kinds of Shaping systems, namely, Shaping in one stage and Shaping in two stages.

The Shaping in one stage applies 1 Rate Shaping. In the 1 Rate Shaping, an average rate included in call setting information is used. In the Shaping in one stage, transmission speed of packets to be sent is adjusted such that the average rate included in the call setting information coincides with the transmission speed of the packets coincide steadily.

The Shaping in two stages applies 2 Rate Shaping. In the 2 Rate Shaping, transmission speed of packets to be sent is adjusted such that speed of the packets approaches an average rate and does not exceed a maximum rate.

The WFQ is a queuing system for, when sizes of packets are irregular, weighting a sending order of the packets and sending the packets. In transmitting the packets using the WFQ, weights are set for queues according to bands and priorities allocated to the respective queues. Therefore, in the WFQ, it is possible to send packets to be sent from plural queues at an arbitrary ratio with respect to the queues. As an example, a case in which, when packets are sent from two queues, a ratio of sending the packets is set as 1:2 with respect to the queues, will be examined. In that case, it is possible to adjust the communication control unit such that, while one packet is sent from one queue, two packets are sent from the other queue. Therefore, in allocating a usable band provided in the communication control unit to a micro-flow, the communication control unit can calculate a minimum guarantee band to be allocated to the micro-flow on the basis of the band provided in the communication control unit and information on a designated band according to call setting information, and can allocate the minimum guarantee band to the micro-flow.

The Best Effort is a queuing system for treating all packets equally, storing the packets in queues in a buffer in order of arriving at the communication control unit, and sending the packets from the queues in order of storing packets.

The call setting information of the communication system has three kinds of service classes, namely, a guarantee type, a relative guarantee type, and a best effort type. The service classes do not have to be set. The service classes are used as an instruction to the communication control unit for realizing the priority control for packets. Communication control units, which identifies the guarantee type, the relative guarantee type, and the best effort type service classes included in call setting information and uses the call setting information for control of a communication quality, correspond to the communication control units including a “band guarantee characteristic”, a “relative band guarantee characteristic”, and a “non-guarantee band characteristic” of the present invention, respectively.

Moreover, the call setting information has two kinds of information on bands, namely, an average rate and a maximum rate (a rate is also called a band, which means transmission speed) The two kinds of information on bands do not have to be set. The communication control unit secures a path for data communication and sets a processing method for packets on the basis of the information on the service classes included in the call setting information and the band information included in the call setting information.

<Processing of Packets>

The communication system processes packets on the basis of setting of the communication control unit according to call setting information. The communication system measures a quantity of flow of packets for each micro-flow before storing the packets in queues in a buffer, judges whether the respective packets should be disposed of according to a result of the measurement, and disposes of the packets judged to be disposed of.

The communication system adopts two kinds of disposal methods for packets. A first disposal method is a method of using a 1 Rate meter and a second disposal method is a method of using a 2 Rate 3 Color meter.

In the 1 Rate method, as a first stage, an actual quantity of flow of packets is measured for each micro-flow. For the respective packets, if a result of measurement of a quantity of flow of received packets at a time is equal to or lower than an average rate included in call setting information, Green is given to the packet. If the result of measurement exceeds the average rate, Red is given to the packet. All packets to which Green is given are transmitted. All packets identified as Red are disposed of.

In the 2 Rate 3 Color method, as in the 1 Rate method, an actual quantity of flow of packets is measured for each micro-flow in a first stage. For respective packets, if a result of measurement of a quantity of flow of received packets at a time is equal to or lower than an average rate included in call setting information, Green is given to the packet. If the quantity of flow falls within a range equal to or higher than the average rate and not exceeding a maximum rate included in the call setting information, Yellow is given to the packet. If the quantity of flow exceeds the maximum rate, Red is given to the packet. All packets to which Green is given are transmitted, that is, are not disposed of. Packets to which Yellow is given are transmitted at a probability of, for example, 1 to 99%. Probability of transmission of the packets used by Yellow is determined dynamically by feeding back amounts of the packets identified as Yellow and packets identified as Green. For example, when the packets identified as Green is about 20% of all the packets, probability of transmission of the packets of Yellow is increased to increase an amount of all the packets. When the packets identified as Green is about 80% of all the packets, probability of transmission of the packets of Yellow is decreased to reduce an amount of all the packets. All packets identified as Red are disposed of.

The communication system disposes of the packet colored Yellow by using RED (Random Early Detection) or WRED (Weighted Random Early Detection). The RED is a method of selecting a packet at random out of packets judges to be disposed of in a result of measurement and disposing of the packet. The WRED is a method of selecting a packet at probability weighted on the basis of sizes or the like of the packets out of packets judged to be disposed of in a result of measurement and disposing of the packet.

The same system as the queuing method used in processing of data may be adopted for transferring call setting information of the communication system.

<<Unit and Operations of the Unit>>

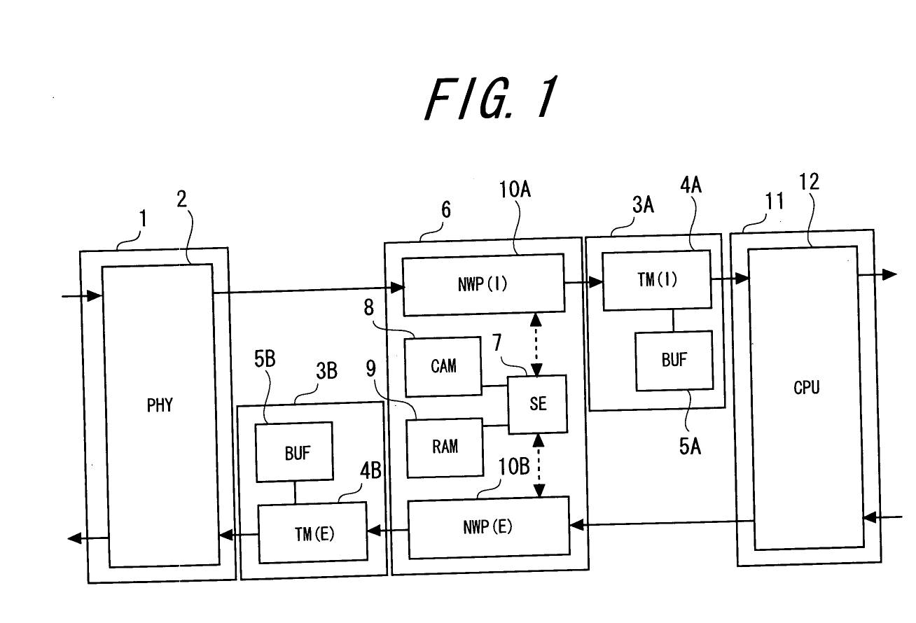

FIG. 1 is a block diagram showing an embodiment of a communication control unit used in the communication system. The communication unit includes a line side interface unit 1, a traffic control units 3A and 3B, a network control unit 6, and an unit control unit 11. The line side interface unit 1 includes a physical connection unit (PHY) 2. The traffic control unit 3A includes a traffic management unit (TM(I)) 4A and a buffer (BUF) 5A. The traffic control unit 3B includes a traffic management unit (TM(E)) 4B and a buffer (BUF) 5B. The network control unit 6 includes a network processing unit (NWP(I)) 10A, a network processing unit (NWP(E)) 10B, a search engine (SE) 7, a content addressable memory (CAM) 8, and a random access memory (RAM) 9. The unit control unit 11 includes a central processing unit (CPU) 12. The respective components will be explained below.

The line side interface unit 1 has means for receiving call setting information and communication information or sends packets to other networks through the physical connection unit 2. The physical connection unit 2 has a chip set for controlling a physical layer. The call setting information and the packets received from the line side interface unit 1 are sent to the network processing unit 10A. The line side interface unit 1 corresponds to the “unit receiving call setting information” of the present invention.

When the network processing unit 10A (10B) receives the call setting information, the network processing unit 10A (10B) passes an IP address or the like of a called communication unit to the search engine 7 and obtains judgment on to which communication unit among the adjacent communication units the call setting information should be sent, that is, information on routing from the search engine 7. The network processing unit 10A (10B) notifies a traffic management unit 4A (4B) of the information on routing. The network processing unit 10A (10B) measures a quantity of flow of packets for each micro-flow (the network processing unit 10A (10B) corresponds to the “unit identifying communication information” of the present invention).

The network processing unit 10A (10B) can receive a packet of request for connection to a partner communication unit from a communication terminal or a communication control unit that does not send the call setting information. The network processing unit 10A (10B) can find out information included in a header of the packet such as an IP address of the partner communication unit from the packet.

The search engine 7 receives the call setting information or the information on the partner communication unit such as an IP address included in the call setting information. The search engine 7 uses the content addressable memory 8 and the random access memory 9 to judge to which communication unit among the adjacent communication units the call setting information should be sent. The search engine 7 returns, to the network processing unit 10A (10B), information on a destination to which the call setting information is sent next, that is, information on an interface of a network to be connected to the next communication unit.

The traffic management unit 4A (4B) sends the call setting information or the information on the partner communication unit such as an IP address included in the call setting information to the search engine 7 and receives the information from the search engine 7 on a destination to which the call setting information is sent next. In a stage of processing of packets, when the traffic control unit 4A (4B) receives a packet flowing through a micro-flow, the traffic control unit 4A (4B) stores the packet in a queue in a buffer 5A (5B) on the basis of the call setting information. In the communication system, the traffic management unit 4A (4B) has three queuing systems, namely, Shaping, WFQ, and Best Effort. The traffic management unit 4A (4B) selects a queuing system for each micro-flow on the basis of the call setting information. The traffic management unit 4A(4B) receives the information on routing from the network processing unit 10A (10B) In a stage in which packets flow, the traffic management unit 4A (4B) sends the packet to the adjacent unit through the line side interface unit 1 on the basis of the selected queuing system and the routing information (the traffic management unit 4A (4B) corresponds to the “transferring unit” of the present invention).

The buffer 5A (5B) has means for storing packets in queues for each queuing system. For example, in the Shaping, logical blocks concerning three buffering are secured. In the WFQ, logical blocks concerning eleven buffering are secured. In this way, many areas of a buffer of a queuing system, which is frequently used, may be secured in the buffer 5A (5B) (the buffer 5A (5B) corresponds to the “storing unit storing including plural storage areas” of the present invention).

The central processing unit 12 is connected to the respective components of the communication control unit through the unit control unit 11, sets conditions for operations of the respective components such as a queuing system and a disposal system (the central processing unit 12 performing the setting corresponds to the “selecting unit selecting any one of plural queues” of the present invention), and watches operation states of the respective components. For example, the central processing unit 12 receives call setting information from a communication unit at a transmission source, when a micro-flow is established from the transmission source to a destination, and allocates resources of the communication control unit to the micro-flow on the basis of the call setting information. The central processing unit 12 watches the communication and resets the resources of the communication control unit. The central processing unit 12 has a communication control program for realizing such functions and executes the communication control program when the request is received.

Call setting information or communication information is received in the physical connection unit 2 in the line side interface unit 1 that is connected to a communication network such as an ATM network or an Ethernet (registered trademark) network. The line side interface unit 2 sends the information to the network control unit 6. The network processing unit 6 processes the information in the network processing unit 10A and sends the information to the traffic control unit 3A. The traffic control unit 3A processes the information in the traffic management unit 4A and sends the information to the unit control unit 11. The unit control unit 11 processes the information in the central processing unit 12 and sends the information to another unit connected to the unit control unit 11.

When the call setting information or the communication information is sent from the inside of the unit to a partner communication unit, the communication control unit receives the information in the unit control unit 11 from another unit. The unit control unit 11 sends the information to the network control unit 6. The network control unit 6 processes the information in the network processing unit 10B and sends the information to the traffic control unit 3B. The traffic control unit 3B processes the information in the traffic management unit 4B and sends the information to the line side interface unit 1. The line side interface unit 1 sends the information to the partner communication unit through the physical connection unit 2.

Therefore, the communication system can receive a request for connection from a communication unit to a partner communication unit, that is, call setting information, on a first network. In addition, the communication system can transfer received call setting information or communication information to a communication unit on a second network.

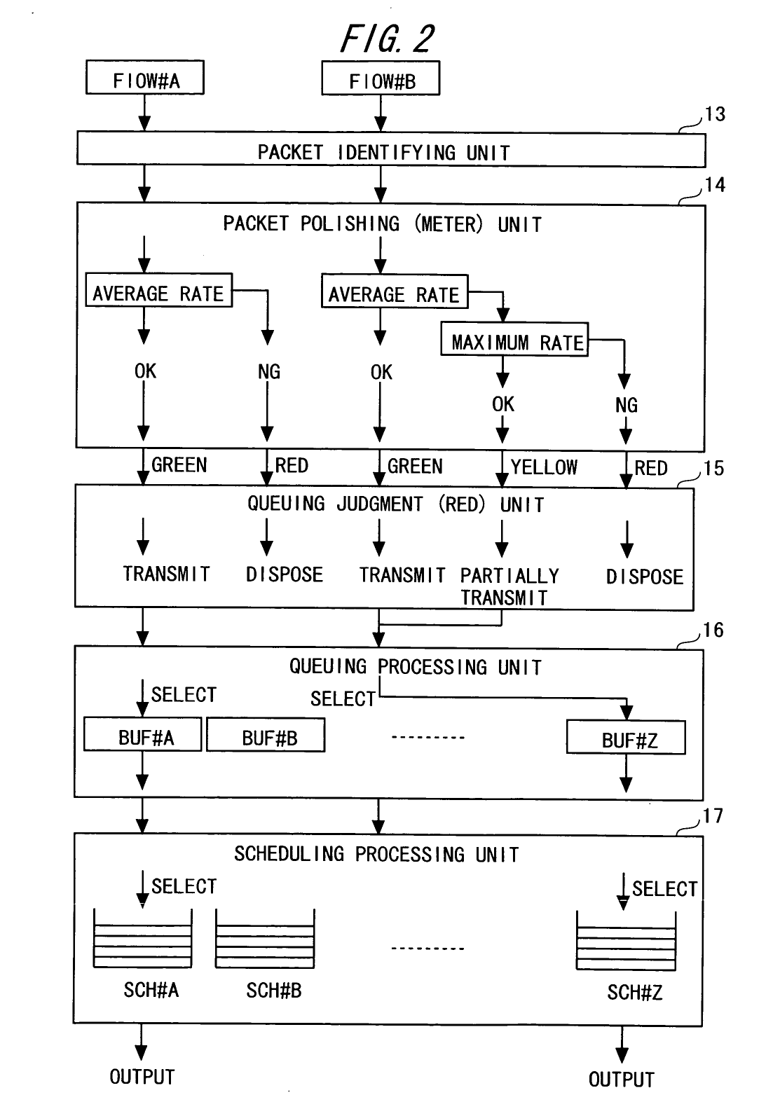

FIG. 2 shows a process in which the traffic control unit 3A (3B) and the network processing unit 10A (10B) process packets flowing on micro-flows. The network processing unit 10A (10B) has a packet identifying unit 13 and a packet polishing (meter) unit 14. The traffic control unit 3A (3B) has a queuing judgment (RED) unit 15, a queuing processing unit 16, and a scheduling processing unit 17.

When the packet identifying unit 13 receives packets, the packet identifying unit 13 measures a quantity of flow of the packets for each micro-flow. For example, the micro-flow can be identified according to a combination of a transmission source address and a destination address of the packets. As the quantity of flow of the packets measured by the packet identifying unit 13, there are a size of a band of the packets, an average length of the packets (an average packet length), and a difference between the size of a band of the packets and an average rate included in call setting information, that is, a magnitude of burstiness. In the communication system, the size of a band of the packets is compared with the average rate (corresponding to the “normal band” of the present invention) included in the call setting information and a maximum rate (corresponding to the “temporary band in an unsteady state” of the present invention) included in the call setting information.

The packet polishing (meter) unit 14 colors the packets in three colors, that is, Green, Yellow, and Red as judgment on disposal of the packets on the basis of the quantity of flow of the packets measured in the packet identifying unit 13. The packet polishing (meter) unit 14 sends the packets to the queuing judgment (RED) unit 15.

The queuing judgment (RED) unit 15 performs processing for the packets colored in the packet polishing (meter) unit 14. The queuing judgment (RED) unit 15 transmits all the packets colored in Green, disposes of a part of the packets colored in Yellow using RED or WRED, and disposes of all the packets colored in Red (the queuing judgment (RED) unit 15 corresponds to the “disposal processing unit” of the present invention). The queuing judgment (RED) unit 15 sends the transmitted packets to the queuing processing unit 16.

In order to sends the packets, the queuing processing unit 16 stores the packets in logical blocks of buffers divided for each queuing system (the queuing processing unit 16 corresponds to the “unit storing packets in queues” of the present invention). However, many areas of a buffer of a queuing system, which is frequently used, may be secured. For example, in the Shaping, three logical blocks for buffer are secured. In the WFQ, eleven logical blocks for buffer are secured.

The scheduling processing unit 17 stores packets sent from the queuing processing unit 16 in queues in the buffer 5A (5B). The scheduling processing unit 17 includes means for processing several kinds of buffer patterns in the buffer 5A (5B) in advance. For example, the buffer 5A (5B) may include several buffer patterns with a short queue length for the Shaping and include several buffer patterns with a long queue length for the WFQ (the buffer 5A (5B) corresponds to the “fixed length queue” of the present invention). In addition, the buffer 5A (5B) may include several buffer patterns with a queue length which may be changed according to a traffic (a quantity of flow) for the Best Effort (the buffer 5A (5B) corresponds to the “variable length queue” of the present invention). If there is information on a maximum rate in the call setting information, the scheduling processing unit 17 may realize efficiency of resources by allocating a smallest queue length among queue lengths larger than the maximum rate.

The scheduling processing unit 17 sends the packets from queues secured in a buffer on the basis of a queuing system instructed by the call setting information. The scheduling processing unit 17 gives a top priority to queues of the Shaping as priorities for queues for the queuing system in sending packets and sends the packets so as to keep the packets at certain fixed speed or between fixed speeds. Queues belonging to the WFQ are given a second highest priority next to the Shaping to send packets. Lastly, the packets are sent from queues belonging to the Best Effort. In sending the packets, the scheduling processing unit 17 may weight an order of transmission of the packets according to a size of an area of a buffer for the queuing system and sends the packets. For example, when there are three areas of a buffer for the Shaping and there are eleven areas of a buffer for the WFQ, a priority of the packets to be sent from the WFQ may be set higher according to a size of the buffer.

Two micro-flows shown in FIG. 2 are set as flow#A and flow#B, respectively. First, concerning an example of flow#A, a process of processing for packets will be explained. Next, concerning flow#B, a difference of a process of processing for packets from that of the micro-flow flow#A will be explained.

In flow#A, first, the packet identifying unit 13 measures a quantity of flow of the packets. The packet polishing (meter) unit 14 allocates any one of colors Green, Yellow, and Red to the packets on the basis of information on bands included in call setting information and the measured quantity of flow. Here, flow#A is an example in which a 1 Rate meter is used, that is, an example in which the packets are colored only in Green and Red. The queuing judgment (RED) unit 15 disposes of the packets on the basis of the colors allocated by the packet polishing (meter) unit 14. Since only the colors Green and Red are allocated in flow#A, the queuing judgment (RED) unit 15 transmits all the packets of Green and disposes of all the packets of Red. The queuing processing unit 16 selects a logical block for the flow#A from logical blocks of the buffers Buf#A to Buf#Z on the basis of the call setting information. The queuing processing unit 16 registers the packets in the selected logical block of the buffer. The scheduling processing unit 17 sends the packets using Sch#A to Sch#Z corresponding to Buf#A to Buf#Z of the queuing processing unit 16, respectively.

Here, flow#B is different from flow#A in that a 2 Rate 3 Color meter is used in the packet polishing (meter) unit 14. Therefore, the packet polishing (meter) unit 14 colors the packets in flow#B with Yellow as well. The queuing judgment (RED) unit 15 uses RED or WRED for disposal of the packets colored Yellow.

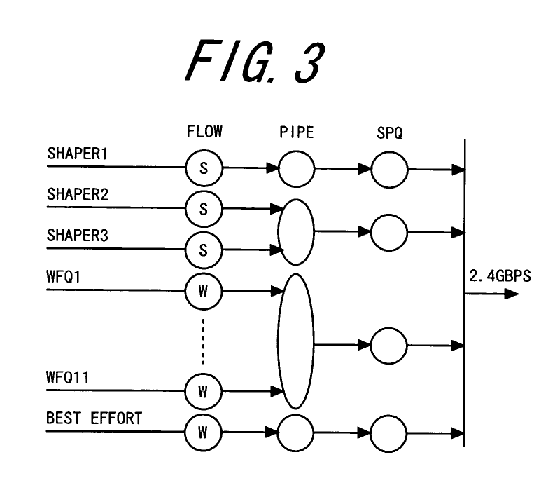

FIG. 3 shows logical blocks of buffers. In FIG. 3, the logical blocks of buffers include first Shaping (SHAPER1 1), second Shaping (SHAPER 2), third Shaping (SHAPER 3), first WFQ (WFQ1), . . . , eleventh WFQ (WFQ11), and Best Effort. Packets sent from the queuing judgment (RED) unit 15 are allocated to the logical blocks of the buffers in accordance with queuing systems set for respective micro-flows. For example, if a micro-flow is set in the Shaping, the packets are allocated to one of first to third logical blocks of the buffers. If a micro-flow is set in the WFQ, the packets are allocated to some of first to eleventh logical blocks of the buffers. The packets sent from the queuing judgment (RED) unit 15 indicate a stage of Flow in FIG. 3. The queuing processing unit 16 combines several logical blocks of the buffers in a stage called PIPE. The queuing processing unit 16 limits a band for the combined blocks and allocates a queue to the buffers. In FIG. 3, the queuing processing unit 16 combines a logical block of a buffer of the second Shaping and a logical block of a buffer of the third Shaping into one logical block. In FIG. 3, the queuing processing unit 16 combines also logical blocks of buffers of WFQ of first to eleventh into one. The next stage called SPQ indicates processing for the logical blocks of the buffers combined in the stage of PIPE. In the stage of SPQ, priority operation for transmission of packets is performed. In the priority operation, a packet at the stage of SPQ of shaper 1 is sent most preferentially, packets at the stage of SPQ of shaper 2 and shaper 3 are sent second most preferentially, packets at the stage of SPQ of wfg1 to wfg11 are sent third most preferentially, and packets at the stage of SPQ of the Best Effort are sent at the last of the priorities. In FIG. 3, 2.4 Gbps (Giga Bit Per Second) is assumed as transmission speed of packets sent from the communication control unit.

### Embodiment

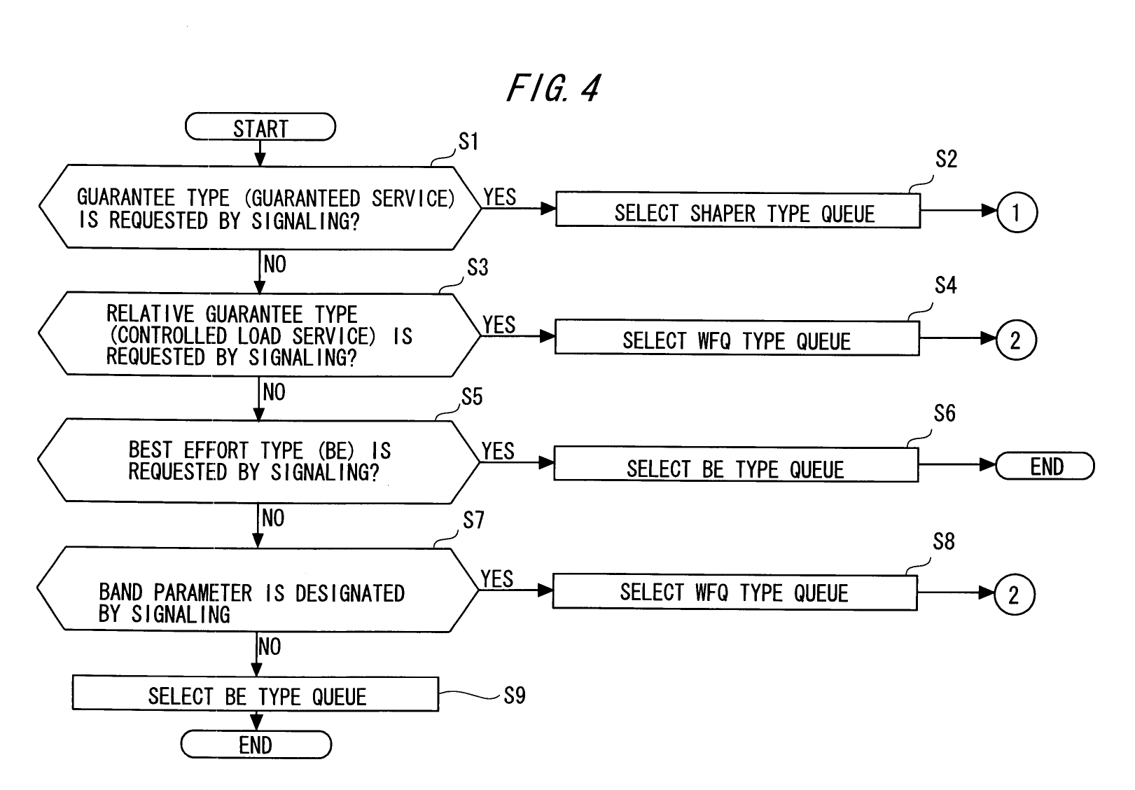

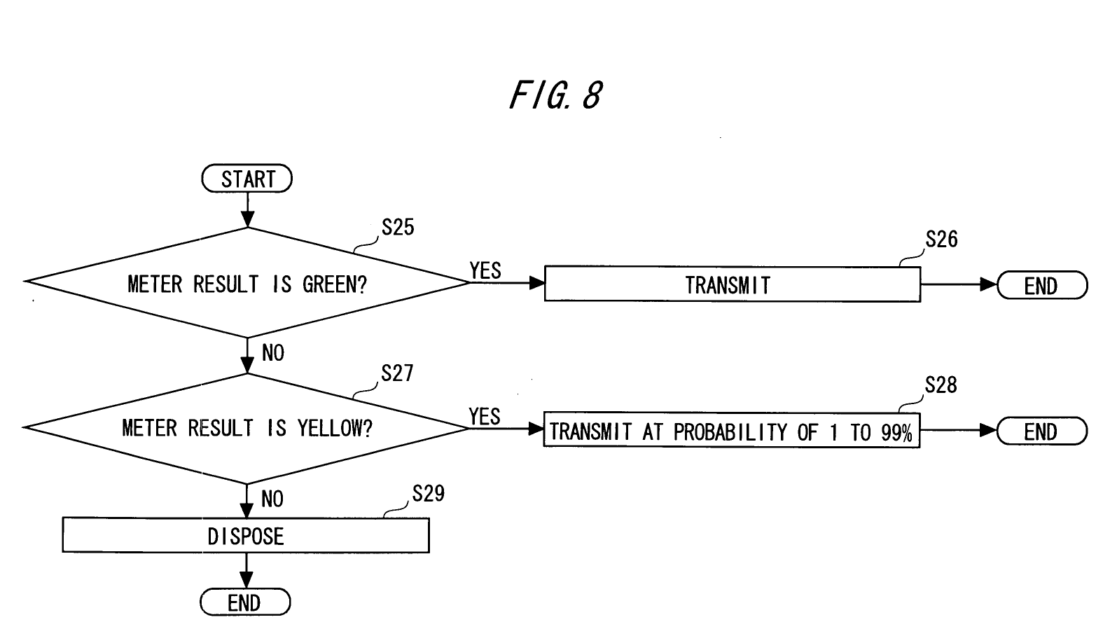

In the following description, an embodiment of setting for a system according to call setting information of the communication system will be explained using a flowchart shown in FIGS. 4 to 7, and an embodiment of processing for packets of the communication system will be explained using a flowchart shown in FIG. 8.

In the embodiment, for convenience of explanation, queues belonging to the three kinds of queuing systems, the Shaping, the WFQ, and the Best Effort, are referred to as a Shaper type queue, a WFQ type queue, and a BE type queue. The Shaper type queue is a one-stage Shaper queue when one-stage Shaping is used. The Shaper type queue is a two-stage Shaper queue when two-stage Shaping is used.

<Setting for the System According to Call Setting Information>

Setting for the system according to call setting information is realized by a communication control program on the central processing unit 12 shown in FIG. 1. The central processing unit 12 performs such setting. In other words, the central processing unit 12 sets required allocation of resources to micro-flows in the network processing unit 10A (10B) and the traffic management unit 4A (4B).

The communication system prepares three types, namely, a guarantee type, a relative guarantee type, and a best effort type, as service classes for priority control for packets designated by call setting information. These service classes are instructed to the communication control unit according to the call setting information. The service classes of the call setting information do not have to be set.

FIG. 4 is a flowchart of processing that is executed first when the communication system receives call setting information (hereinafter referred to as signaling packet or simply referred to as signaling). In addition, FIG. 4 is a flowchart of processing for registering service classes in the communication control unit in order to perform priority control for packets on the basis of designation of service classes of the call setting information. The processing is executed by a control program of the central processing unit 12 in FIG. 1.

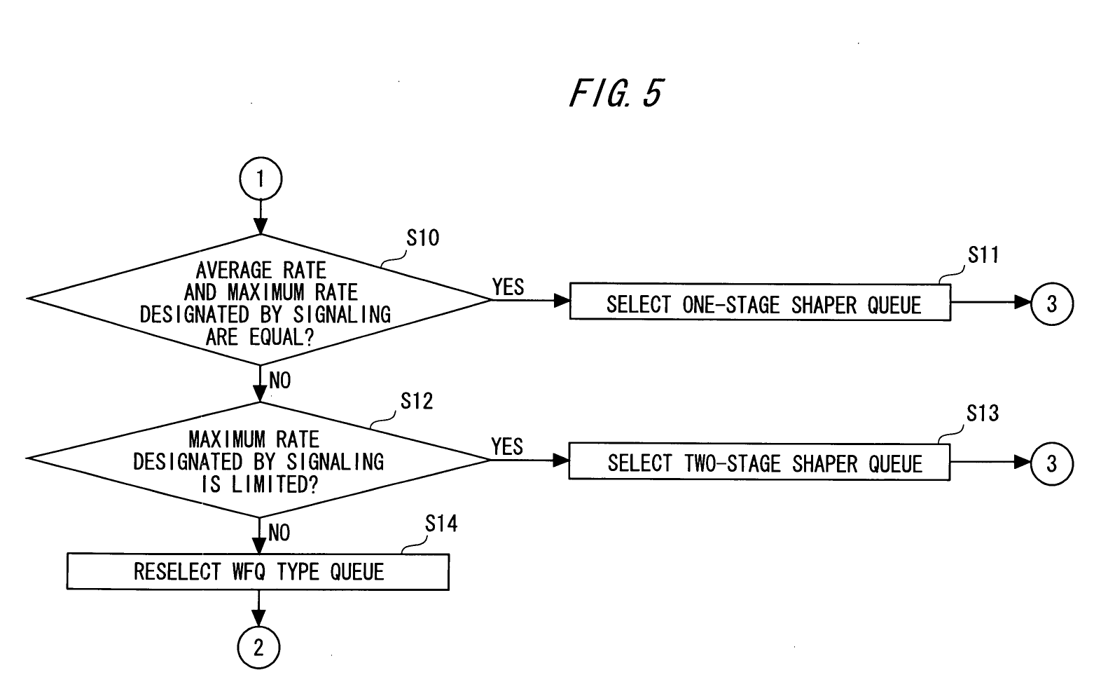

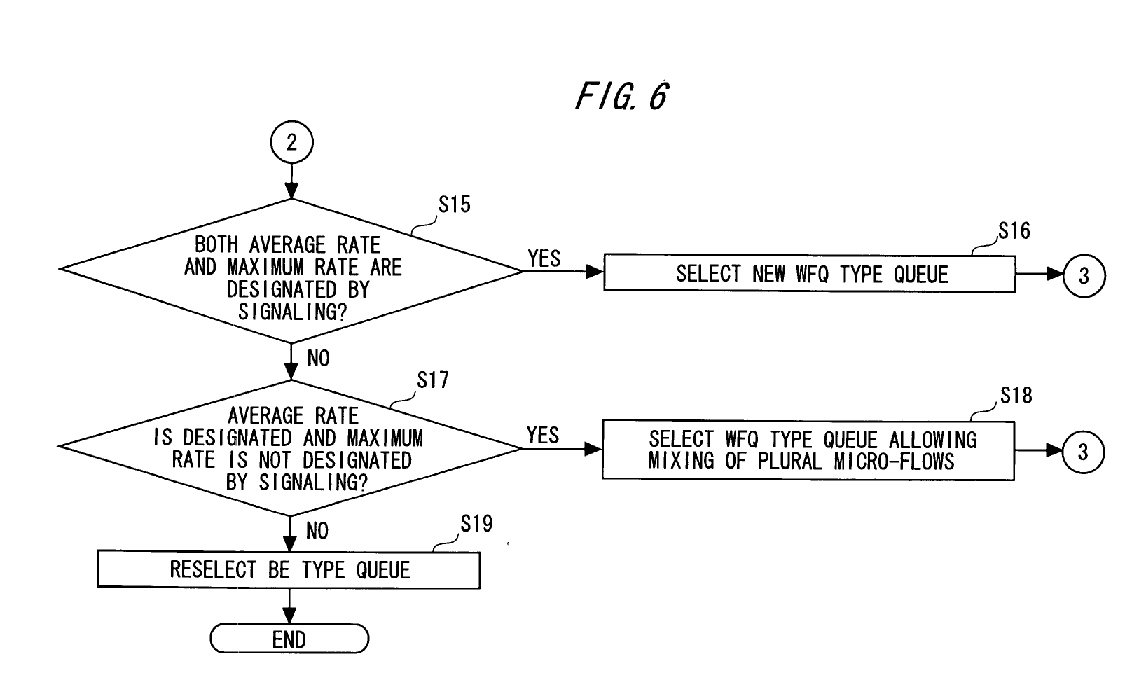

In the processing, first, the central processing unit 12 judges whether the guarantee type (Guaranteed Service) is requested in the call setting information (signaling) (S1). If it is judged in step S1 that the guarantee type is requested, the central processing unit 12 sets the shaper type queue in the communication control unit for micro-flows established in the call setting information and proceeds to step S10 in FIG. 5 (S2). If the guarantee type is not requested in step S1, the central processing unit 12 judges whether the relative guarantee type (Controlled Load Service) is requested by the signaling (S3). If it is judged in step S3 that the relative guarantee type is requested, the central processing unit 12 sets the WFQ type queue in the communication control unit and proceeds to step S15 in FIG. 6 (S4). If the relative guarantee type is not requested in step S3, the central processing unit 12 judges whether the best effort type (BE) is requested by the signaling (S5). If it is judged in step S5 that the best effort type is requested, the central processing unit 12 sets the BE type queue in the communication control unit and ends the setting of the queuing system (S6). If the best effort type is not requested in step S5, the central processing unit 12 judges whether a band parameter is designated by the signaling (S7). If a band parameter is designated in step S7, the central processing unit 12 sets the WFQ type in the communication control unit and proceeds to step S15 in FIG. 6 (S8). If a band parameter is not designated in step S7, the central processing unit 12 sets the BE type queue in the communication control unit and ends the setting of the queuing system.

According to the steps described above, the communication control unit can register a service class in the communication control unit on the basis of the call setting information.

The call setting information can also include information for designating bands for an average rate and a maximum rate as designation concerning a transmission band of packets other than the information on designation of a service class.

FIG. 5 is a second flowchart for setting for the system according to the call setting information of the communication system. The flowchart of processing shown in FIG. 5 is processing for a micro-flow for which the shaper type queue is selected. In the processing, processing for narrowing down the queuing system and resetting of the queuing system is further executed on the micro-flow on the basis of information on setting of a band of the call setting information.

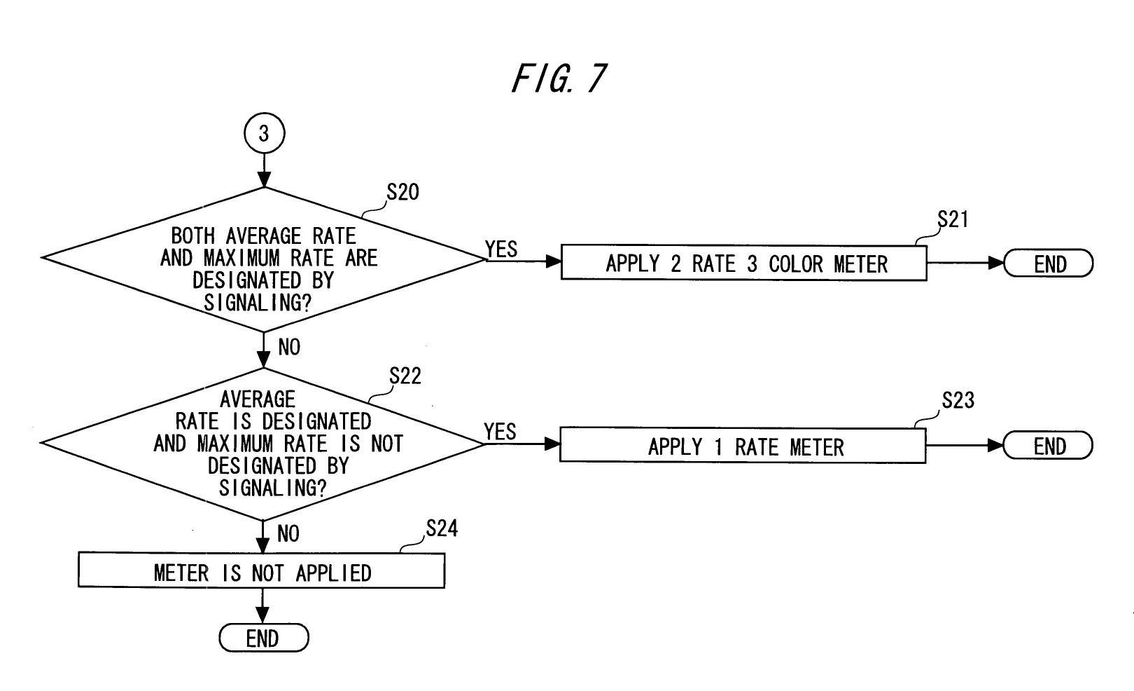

In the processing, first, the central processing unit 12 judges whether an average rate and a maximum rate designated by signaling are equal (S10). If it is judged in step S10 that the average rate and the maximum rate are equal, this micro-flow needs to send packets always at specific transmission speed. Therefore, the central processing unit 12 sets a one-stage shaper queue in the communication control unit and proceeds to step S20 in FIG. 7 (S11). Specifically, the communication control unit sets setting information in the packet identifying unit 13 such that the micro-flow is treated as the one-stage shaper queue. Thereafter, setting information of a queue for the micro-flow is set in the packet identifying unit 13 in the same manner.

If it is not judged in step S10 that the average rate and the maximum rate are equal, the central processing unit 12 judges whether an average rate and a maximum rate are designated by signaling and a value of the maximum rate is a finite value (S12). If it is judged in step S12 that an average rate and a maximum rate are designated by signaling and a value of the maximum rate is a finite value, the communication control unit is requested to perform communication at transmission speed between the average rate and the maximum rate. Thus, the central processing unit 12 sets a two-stage shaper queue in the communication control unit and proceeds to step S20 in FIG. 7 (S13). If it is judged in step S12 that an average rate or a maximum rate is not designated or a maximum rate is unlimited, this means that an upper limit of transmission speed of packets does not have to be set. The central processing unit 12 selects the WFQ type queue again, sets the WFQ type queue in the communication control unit, and proceeds to step S15 in FIG. 6 (S14).

According to such setting, the communication control unit can further apply narrowing-down of the queuing system and resetting of the queuing system to the micro-flow selected as the shaper type queue on the basis of an instruction for transmission speed of the call setting information.

The communication control unit can set a communication path with controlled transmission speed for a communication which it is necessary for a user to strictly define an upper limit of packet transmission speed. In addition, for a communication which packet transmission speed for a user may exceed usual transmission speed temporarily, the communication control unit can set a communication path accordingly with the two-stage shaper queue. Moreover, for a communication which it is unnecessary for a user to limit maximum transmission speed of packets, the communication control unit only has to set a communication path with the WFQ type queue rather than the rare shaper queue.

FIG. 6 is a third flowchart for setting for the system according to the call setting information of the communication system. In the flowchart of processing shown in FIG. 6, the processing is processing for a micro-flow selected as the WFQ type queue. In the processing, the communication control unit further executes processing such as narrowing-down of a queuing system and resetting of a queuing system on the micro-flow on the basis of information on setting of a band of call setting information.

In the processing, first, the central processing unit 12 judges whether both an average rate and a maximum rate are designated by signaling (S15). If it is judged in step S15 that both an average rate and a maximum rate are designated, the central processing unit 12 sets a queue in the communication control unit such that a new WFQ type queue, that is, a queue for WFQ, which other micro-flows is not used, is secured as much as possible. The central processing unit 12 proceeds to step S20 (S16). The central processing unit 12 sets the new WFQ type key in the communication control unit because, when plural micro-flows are mixed in a WFQ type queue or when packet transmission speed of one micro-flow falls (or when packet transmission of the micro-flow stops), it is highly likely that transmission speed of packets designated in the other micro-flow exceeds a maximum value of the transmission speed of the packet designated in the micro-flow.

When both an average rate and a maximum rate are not designated in step S15, the central processing unit 12 judges whether an average rate is designated and a maximum rate is not designated by signaling (S17). If an average rate is designated and a maximum rate is not designated by signaling in step S17, the central processing unit 12 sets a WFQ type queue, which allows mix of plural micro-flows, in the communication control unit. This means that queues from plural micro-flows may be stored in an area of a buffer set for WFQ. The central processing unit 12 proceeds to step S20 in FIG. 7 (S18). This is because, when a maximum rate is not designated, it does not matter even if packets of plural micro-flows are mixed.

When the central processing unit 12 judges in step S17 that an average rate is designated and a maximum rate is not designated by signaling, it is judged that there is no specific instruction concerning transmission speed by the signaling. Thus, the central processing unit 12 sets the BE type queue in the communication control unit and ends the setting of the queuing system (S19).

According to such setting, the communication control unit can further apply narrowing-down of the queuing system and resetting of the queuing system to the micro-flow selected as the WFQ type queue on the basis of an instruction for transmission speed of the call setting information.

On the basis of a result of actually measuring a packet, which flows into the communication control unit, for each micro-flow (a result of measurement by a meter), the communication system executes processing for disposing of the packet when the result does not meet a predetermined standard. The communication system adopts two kinds of methods, namely, a method of applying a 1 Rate meter and a method of applying a 2 Rate 3 Color meter, as a method of disposing of a packet. The central processing unit 12 judges a method of disposal to be adopted on the basis of information on designation of transmission speed included in call setting information.

FIG. 7 is a fourth flowchart for setting for the system according to call setting information of the communication system. The communication control unit judges a method of disposal to be adopted on the basis of information on designation of a transmission band included in the call setting information. The communication system applies disposal by a meter only to the shaper type queue and the WFQ type queue.

In the processing, first, the central processing unit 12 judges whether both an average rate and a maximum rate are designated by signaling (S20). If both an average rate and a maximum rate are designated by signaling in step S20, the central processing unit 12 sets a 2 Rate 3 Color meter in the communication control unit as a method of identifying a packet to be disposed of using the average rate and the maximum rate, and ends setting for a queuing system (S21).

If both an average rate and a maximum rate are not designated by signaling in step S20, the central processing unit 12 judges whether an average rate is designated and a maximum rate is not designated by signaling (S22). If an average rate is designated and a maximum rate is not designated by signaling in step S22, the central processing unit 12 sets a 1 Rate meter in the communication control unit as a method of identifying a packet to be disposed of using the average rate, and ends setting of a queuing system (S23). The communication control unit having means, which sets and executes the 1 Rate meter, corresponds to the “first disposal object classifying unit” of the present invention. If an average rate is not designated or a maximum rate is designated but an average rate is not designated by signaling in step S22, there is no instruction for an average rate by signaling. Therefore, the communication control unit sets an indication that a meter is not applied in the communication control unit, and ends setting of a queuing system.

According to such setting, the communication control unit can further apply setting of the packet disposal method to the micro-flow selected as the shaper type queue or the WFQ type queue or the WFQ type queue on the basis of an instruction for transmission speed of the call setting information.

<Processing of Packets>

A step of measuring packets flowing into the communication control unit for each micro-flow and processing the packets on the basis of a result of the measurement will be explained.

FIG. 8 is a flowchart showing processing for disposing of packets by a 2 Rate 3 Color meter that is performed in the communication system. In a method of 2 Rate 3 Color, judgment on disposal is executed by coloring of packets.

First, the packet polishing (meter) unit 14 judges whether packets are identified as Green according to a result of a meter in the packet identifying unit 13 (S25). The packets identified as Green are packets that flow into the communication control unit in a band smaller than an average rate included in call setting information. Therefore, the packets are packets in which congestion does not occur if the communication control unit secures a band as large as the average rate. If it is judged in step S25 that the packets are Green, the queuing judgment (RED) unit 15 judges that all the packets are transmitted without being disposed of. The queuing judgment (RED) unit 15 sends the packets, which are judged to be transmitted, to the queuing processing unit 16 (S26). If the packets are not identified as Green in step S25, the packet polishing (meter) unit 14 judges whether the packets are identified as Yellow according to a result of measurement of a quantity of flow of the packets (a result of a meter) (S27). The packets identified as Yellow are packets that flow into the communication control unit in a band larger than the average rate included in the call setting information and smaller than a maximum rate. Therefore, the packets are packets in which congestion is likely to occur if the communication control unit secures a band as large as the average rate. If the packets are identified as Yellow in step S27, the queuing judgment (RED) unit 15 sends, for example, 1 to 99% of the packets to the queuing processing unit 16 and disposes of the remaining packets. If the packets are not judged Yellow in step S27, the packet polishing (meter) unit 14 judges the packets as Red. If the packets are judged as Red, the queuing judgment (RED) unit 15 disposes of all the packets (S29). The packets identified as Red are packets that flow into the communication control unit in a band larger than the maximum rate included in the call setting information. Therefore, if the communication control unit secures a band as large as the average rate, the packets are packets in which congestion is likely to occur at high probability.

According to the processing described above, the communication control unit can dispose of packets, which are judged to be disposed of, for each color attached to the packets (the queuing judgment (RED) unit 15 executing the 2 Rate 3 Color meter corresponds to the “second disposal object classifying unit” of the present invention).

It is possible to control a processing load of software by, as described above, using the identification of call setting information, the queuing system designated by the call setting information, the selection of packets on the basis of a result of measurement of a quantity of flow of the packets, and the scheduling method concerning transmission of the packets. Therefore, it is possible to control soaring of equipment cost corresponding to an increase in the number of micro-flows included in the system such as Intserv. The present invention can also be applied to other method of performing data communication after securing a path using call setting information.

<<Modification>>

In this embodiment, more detailed packet control may be performed by using information other than call setting information to correct a queuing system, to which micro-flows belong, periodically.

In the processing, a queuing system, to which micro-flows belong, is corrected dynamically in response to inflow of packets. In the processing, an average length of packets not included in the call setting information and a magnitude of burstiness of the packets may be used for the correction of a queuing system, to which micro-flows belong. In the processing, information on priority control for packets, which is included in a header of packets flowing into the communication control unit at the time of data communication such as an IP packet and an MPLS, may be used.

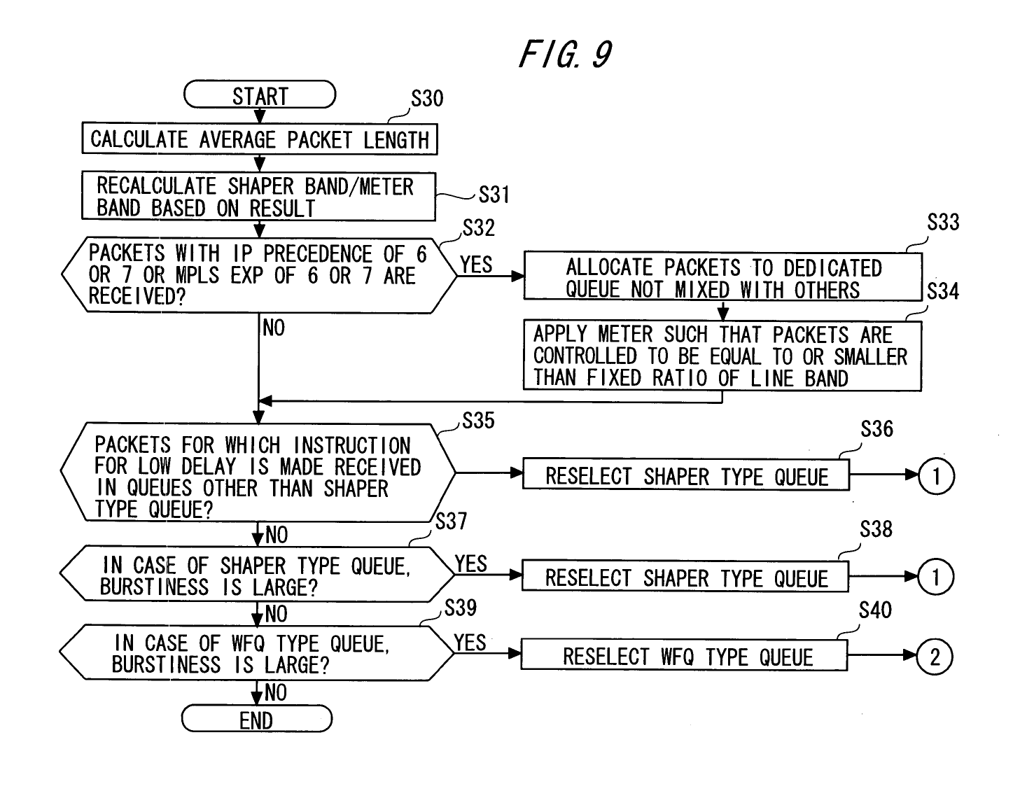

FIG. 9 is a flowchart showing processing for periodically correcting a queuing system, to which micro-flows belong, performed in the communication system. In the processing, first, the packet identifying unit 13 calculates an average length of packets (the packet identifying unit 13 corresponds to the “unit calculating an average data length” of the present invention) (S30). If the shaper type queue is designated, the packet polishing (meter) unit recalculates a band to be used in the shaper type queue on the basis of a result of the calculation of an average packet length and allocates a band of the shaper type queue again on the basis of a result of the calculation. The packet polishing (meter) unit also allocates a meter band on the basis of the result of the calculation (S31). The packet polishing (meter) unit corresponds to the “unit correcting a transfer band” of the present invention. In the recalculation of a band to be used in the shaper type queue, it is assumed that variable length packets are received in the communication control unit. For example, it is assumed that an average packet length is calculated as 129 bytes. In this embodiment, it is assumed that communication data is processed in a cell by a unit of 128 bytes. In that case, the packets of the average 129 bytes are highly likely to be divided into a cell of 128 bytes and a second cell including a free space of 127 bytes (a cell storing data by average 1 byte) and processed. Therefore, the communication control unit processes the packets of average 129 bytes twice and a practical band is reduced to one half. Thus, in such a case, the communication control unit may adjust the band to reduce a free space of the cell. With this processing, it is possible to use the resources of the communication control unit more effectively.

Next, the packet polishing (meter) unit 14 judges whether a packet is received that IP Precedence included in a header of the IP packet is 6 or 7, where IP Precedence is information for priority control for an IP packet, or judges whether a packet is received that EXP included in a header of the MPLS is 6 or 7, where EXP is information for priority control for MPLS (S32). If it is judged in step S32 that the IP precedence is 6 or 7 or the EXP is 6 or 7, the queuing processing unit 16 allocates the packets to unused buffers as dedicated queues (S33). With this processing, it is possible to reflect the information on priority control for packets included in the IP packet or the MPLS to the communication system.

Next, the queuing judgment (RED) unit 15 disposes of the packets such that the received packets are equal to or smaller than a fixed ratio of a line band in order to avoid congestion (S34). With this processing, it is possible to avoid congestion even in specific dedicated queues that are not mixed with other micro-flows.

Next, the packet identifying unit 13 judges whether packets including an instruction of low delay, which is information for priority control for an IP packet and included in a header of the IP packet, are received in queues other than the shaper type queue (S35). If packets including an instruction of low delay are received in queues other than the shaper type queue, in order to set priority on the queues, the network processing unit 10A (10B) resets the micro-flow in the communication control unit as the shaper type queue, proceeds to step S10 in FIG. 5, and narrows down or resets the queuing system (the network processing unit 10A (10B) corresponds to the “first reselecting unit selecting queues again”) (S36). With this processing, it is possible to reflect the instruction for low delay in the IP packet to the communication system.

If the packet identifying unit 13 does not receives packets including an instruction for low delay in queues other than the shaper type queue in step S35, when the shaper type queue is selected, the packet identifying unit 13 calculates a quantity of flow of packets equal to or larger than an average rate during a certain predetermined time, that is, a magnitude of burstiness. The packet polishing (meter) unit 14 judges whether the magnitude of burstiness is larger than a predetermined value set in the communication control unit in advance (S37). If it is judged in step S37 that the magnitude of burstiness is larger than the predetermined value, the network processing unit 10A (10B) sets the magnitude of burstiness to be used instead of the maximum rate in the call setting information, reselects and sets the shaper type queue, proceeds to step S10 in FIG. 5, and narrows down or resets the queuing system (the network processing unit 10A (10B) corresponds to the “second reselecting unit selecting queues again” of the present invention) (S38). With this processing, it is possible to perform the Shaping with more detailed information on the maximum rate.

In step S37, in cases other than the shaper type queue, or it is judged that a magnitude of burstiness during a predetermined time is small in the shaper type queue and the WFQ type queue is selected, the network processing unit 10A (10B) calculates a magnitude of burstiness of packets during the predetermined time. The packet polishing (meter) unit 14 judges whether the magnitude of burstiness is larger than a predetermined value set in the communication control unit in advance (S37). If it is judged in step S37 that the magnitude of burstiness is larger than the predetermined value, the network processing unit 10A (10B) sets the magnitude of burstiness to be used instead of the maximum rate in the call setting information, reselects and sets the WFQ type queue, proceeds to step S15 in FIG. 6, and narrows down or resets the queuing system (S40). With this processing, it is possible to perform the WFQ with more detailed information on the maximum rate.

In step S39, in cases other than the WFQ type queue or if it is judged that a magnitude of burstiness during a predetermined time is small in the WFQ type queue, the network processing unit 10A (10B) ends the setting for correction of the queuing system.

With such setting, the communication control unit can correct a queuing system, to which micro-flows belong, dynamically on the basis of information on packets flowing into the communication control unit.

<Incorporation by Reference>

The disclosures of Japanese patent application No. JP2005-95417 filed on Mar. 29, 2005 including the specification, drawings and abstract are incorporated herein by reference.

What is claimed is:

1. A communication control unit comprising:
a unit receiving call setting information for requesting setting of a communication path that connects a calling communication unit on a first network to a called communication unit on a second network;
a storing unit storing including plural storage areas temporarily accumulating, in transferring communication information transmitted from the first network to the second network through the communication path, the communication information temporarily following wait for transfer;
a storage control unit forming plural queues having different communication qualities for the communication information due to the wait for transfer, in reading out the communication information from the storage areas;
a unit selecting any one of the plural queues according to designation of the call setting information; and
a transferring unit transferring the communication information of the first network to the second network according to the quality of communication through the selected queue.

2. The communication control unit according to claim 1, further comprising:
a unit identifying communication information received between the calling communication control unit and the called communication unit; and
a unit storing the identified communication information in the selected queue.

3. A communication control unit according to claim 1,
wherein the call setting information includes requested band information designating a necessary bandwidth of the communication path, and
wherein the communication control unit further comprises:
a first disposal object classifying unit classifying, when a normal bandwidth to be used normally is designated as the requested band information, communication information as an object to be disposed of in the communication path on the basis of the normal bandwidth; and
a second disposal object classifying unit classifying, when a temporary bandwidth or an amount of information transferred by the temporary bandwidth in an unsteady state is designated as the requested band information other than the normal bandwidth to be used normally, communication information as an object to be disposed of in the communication path in two stages on the basis of the normal bandwidth and the temporary bandwidth or in two stages on the basis of the normal bandwidth and the amount of transferred information.

4. The communication control unit according to claim 3, further comprising:
a disposal processing unit disposing of the communication information according to a disposal procedure different for each piece of the classified communication information.

5. The communication control unit according to claim 1,
wherein the storing unit includes one or more fixed length queues in which the number of pieces of the communication information to be stored is limited to be equal to or lower than a predetermined value, and one or more variable length queues in which the number of pieces of the communication information to be stored is variable.

6. The communication control unit according to claim 1,
wherein the communication quality due to the wait for transfer through the storing unit comprises a band guarantee characteristic with which a bandwidth of communication information is guaranteed, a relative band guarantee characteristic with which relative priorities for plural storing units are guaranteed, or a non-guarantee band characteristic without bandwidth guarantee.

7. The communication control unit according to claim 1,
wherein queues include a fixed speed readout unit reading out communication information stored at a predetermined fixed speed or at a speed less than a predetermined fixed speed, a weighted readout unit reading out communication information at a rate of relative readout speed among related plural queues, or a unfixed readout unit reading out communication information without control of readout speed.

8. The communication control unit according to claim 1, wherein:
the communication quality includes a transfer bandwidth for transferring the communication information;
the transferring unit divides communication information into communication information of a fixed data length and transfers the communication information; and
the communication control unit further comprises:
a unit calculating an average data length of communication information passing through the communication path; and
a unit correcting the transfer bandwidth on the basis of a relation between the average data length and the fixed data length.

9. The communication control unit according to claim 1, further comprising:
a reselecting unit selecting a queue transferring the communication information again on the basis of priority designation information which is set in the communication information to be transferred through the communication path and indicates a priority at the time of transfer of the communication information.

10. The communication control unit according to claim 1, further comprising:
a unit calculating a temporary bandwidth in an unsteady state of communication information to be transferred through the communication path; and
a reselecting unit selecting a queue transferring the communication information again when the temporary bandwidth in the unsteady state is larger than a predetermined value.

11. A communication control method comprising:
a step of receiving call setting information for requesting setting of a communication path that connects a calling communication unit on a first network to a called communication unit on a second network;
a storing step of, in transferring communication information transmitted from the first network to the second network through the communication path, storing temporarily the communication information in plural storage areas following wait for transfer;
a storage control step of forming plural queues having different communication qualities for the communication information due to the wait for transfer between communications in reading out the communication information from the respective storage areas;
a selecting step of selecting any one of the plural queues according to designation of the call setting information; and
a transferring step of transferring the communication information of the first network to the second network according to the quality of communication through the selected queue.

12. The communication control method according to claim 11, further comprising:
a step of identifying communication information received between the calling communication control unit and the called communication unit; and
a step of storing the identified communication information in the selected queue.

13. The communication control method according to claim 11,
wherein the call setting information includes requested band information designating a necessary bandwidth of the communication path, and
wherein the communication control method may further comprise:
a first disposal object classifying step of classifying, when a normal bandwidth to be used normally is designated as the requested band information, communication information as an object to be disposed of in the communication path on the basis of the normal bandwidth; and
a second disposal object classifying step of classifying, when a temporary bandwidth or an amount of information transferred by the temporary bandwidth in an unsteady state is designated as the requested bandwidth information other than the normal bandwidth to be used normally, communication information as an object to be disposed of in the communication path in two stages on the basis of the normal bandwidth and the temporary bandwidth or in two stages on the basis of the normal bandwidth and the amount of transferred information.

14. The communication control method according to claim 13, further comprising:
a disposal processing step of disposing of the communication information according to a disposal procedure different for each piece of the classified communication information.

15. The communication control method according to claim 11,
wherein the storing step includes storing the communication information into one or more fixed length queues in which the number of pieces of the communication information to be stored is limited to be equal to or lower than a predetermined value, or one or more variable length queues in which the number of pieces of the communication information to be stored is variable.

16. The communication control method according to claim 11,
wherein the communication quality due to the wait for transfer through the storing step comprises a band guarantee characteristic with which a bandwidth of communication information is guaranteed, a relative band guarantee characteristic with which relative priorities among plural storing steps are guaranteed, or a non-guarantee band characteristic without bandwidth guarantee.

17. The communication control method according to claim 11,
wherein the queues include a fixed speed readout step of reading out stored communication information at a predetermined fixed speed or at a speed less than a predetermined fixed speed, a weighted readout step of reading out communication information at a rate of relative readout speed among related plural queues, or an unfixed readout step of reading out communication information without control of readout speed.

18. The communication control method according to claim 11, wherein:
the communication quality includes a transfer bandwidth for transferring the communication information;
the transferring step includes dividing communication information into communication information of a fixed data length and transfers the communication information; and
the communication control method further comprises:
a step of calculating an average data length of communication information passing through the communication path; and
a step of correcting the transfer bandwidth on the basis of a relation between the average data length and the fixed data length.

19. The communication control method according to claim 11, further comprising:
a reselecting step of selecting a queue transferring the communication information again on the basis of priority designation information which is set in the communication information to be transferred through the communication path and indicates a priority at the time of transfer of the communication information.

20. The communication control method according to claim 11, further comprising:
a step of calculating a temporary bandwidth in an unsteady state of communication information to be transferred through the communication path; and
a reselecting step of selecting a queue transferring the communication information again when the temporary bandwidth in the unsteady state is larger than a predetermined value.
